(19) United States
(12) Patent Application Publication
(10) Pub. No.: US 2010/0092648 A1
(43) Pub. Date: Apr. 15, 2010

(54) Culinary Sauce Substantially Free Of Allergens

(76) Inventor: Vilaiwan U. FISCHER, Indianapolis, IN (US)

Correspondence Address: BARNES & THORNBURG LLP, 11 SOUTH MERIDIAN, INDIANAPOLIS, IN, 46204, US

(21) Appl. No.: 12/578,792

(22) Filed: Oct. 14, 2009

Related U.S. Application Data
(60) Provisional application No. 61/105,160, filed on Oct. 14, 2008.

(51) Int. Cl. A23L 1/39; B02C 23/20; A23L 1/221

(52) U.S. Cl. 426/589; 426/508

(57) ABSTRACT

A substitute for traditional sauces used in the preparation of oriental style cuisine is disclosed. The sauce is substantially free of major food allergens so that individuals with common food allergies can enjoy the sauce without suffering from an allergic reaction.

This application claims priority under 35 U.S.C. §119(e) to U.S. Provisional Application Ser. No. 61/105,160, filed Oct. 14, 2008, which is expressly incorporated by reference herein.

### TECHNICAL FIELD

The present disclosure pertains generally to culinary formulations. More specifically, the present disclosure pertains to a curry paste and a substitute for peanut sauce that is substantially free of peanuts and other major food allergens.

### BACKGROUND

Many people enjoy oriental cuisine. Traditionally, oriental sauces, such as peanut sauce, contain common food allergens such as peanuts, wheat, shrimp, and soy. The presence of these ingredients in food may result in an allergic reaction in individuals who handle or consume the food.

An allergic response occurs when the immune system reacts to a certain food. This may trigger a cascade of symptoms affecting the respiratory system, gastrointestinal tract, skin, and/or cardiovascular system. Scientists estimate that approximately 12 million Americans suffer from food allergies. A particular danger is Anaphylaxis. Anaphylaxis is a serious allergic reaction that is rapid in onset and may cause death. Food allergy is believed to be the leading cause of anaphylaxis outside the hospital setting, causing an estimated 30,000 emergency department visits each year in the United States.

Typically, individuals with food allergies strictly avoid consumption of foods that contain allergens in order to avert a potential allergic response. Unfortunately, traditional oriental sauces typically contain common allergens including shrimp, soy, wheat, and/or peanuts. As a result, many people with food allergies avoid consumption of oriental sauces. Thus, a flavorful substitute for traditional oriental sauces that is substantially free of common food allergens is desirable.

### SUMMARY OF THE INVENTION

According to one illustrative embodiment of the invention, a food product comprising a massaman curry paste is disclosed. The curry paste consists essentially of an aqueous base, pepper, garlic, galangal, lemongrass, kaffir lime peel, coriander seeds, clove, and cumin, and is substantially free of major allergens.

The aqueous base of the curry paste may include water, rice milk, rice drink, coconut milk, coconut drink, or the like, or any combination thereof.

According to another illustrative embodiment of the invention, a food product comprising a culinary sauce is disclosed. The culinary sauce consists essentially of an aqueous base, massaman curry paste, sunflower butter, an acidic solution, sugar, sunflower seeds, and salt, and is substantially free of major allergens.

The aqueous base of the sauce may include water, rice milk, rice drink, coconut milk, coconut drink, or the like, or any combination thereof.

The acidic solution may include tamarind, orange juice, lemon juice, grapefruit juice, tomato juice, vinegar, or the like, or any combination thereof.

According to another illustrative embodiment of the invention, a food product comprising a culinary sauce is disclosed. The culinary sauce consists essentially of an aqueous base, massaman curry paste, sunflower butter, an acidic solution, sugar, and salt, and is substantially free of major allergens.

Citric acid may be added to the sauce formulations to lower the pH and promote freshness during storage.

### DETAILED DESCRIPTION

The following terms as used throughout the specification are intended to have the meaning set forth below:

“Major food allergens” include milk, eggs, fish, Crustacean shellfish, tree nuts, wheat, peanuts, and soybeans. According to the United States Food and Drug Administration, major food allergens under the Food Allergen Labeling and Consumer Protection Act include milk, eggs, fish, Crustacean shellfish, tree nuts, wheat, peanuts, and soybeans.

The phrase “substantially free of major food allergens” refers to the absence of a particular allergenic food substance or, if present, present in such an amount that is insufficient to elicit an allergic reaction in an individual. Examples of major food allergens include milk, eggs, fish, Crustacean shellfish, tree nuts, wheat, peanuts, and soybeans.

“Curry paste” or “massaman paste” or “massaman curry paste” are used interchangeably, and refer to a curry paste formulation as described according to Example I of the specification.

“Acidic solution” refers to an edible acid ingredient that has the effect of lowering the pH of the sauce.

While the invention is susceptible to various modifications and alternative forms, specific embodiments will herein be described in detail. It should be understood, however, that there is no intent to limit the invention to the particular forms described, but on the contrary, the intention is to cover all modifications, equivalents, and alternatives falling within the spirit and scope of the invention.

In accordance with one illustrative embodiment of the invention a sauce is prepared that is substantially free of major allergenic food substances. According to the United States Food and Drug Administration, major food allergens under the Food Allergen Labeling and Consumer Protection Act include milk, eggs, fish, Crustacean shellfish, tree nuts, wheat, peanuts, and soybeans.

The sauce may be used as a substantially allergen free substitute sauce in the preparation of cuisine that traditionally contains peanut sauce, including but not limited to chicken, steak, stir fry, and noodle based dishes. Additionally, the sauce may be used as a dipping sauce or as a dressing for salad.

In accordance with another embodiment of the invention, a massaman curry paste is disclosed. The massaman curry paste comprises about 45% to about 55% aqueous base, about 15% to about 25% pepper, about 10% to about 25% onion, about 2% to about 5% garlic, about 2% to about 5% galangal, about 2% to about 5% lemongrass, about 0.3% to about 0.8% kaffir lime peel, about 0.3% to about 0.8% coriander seeds, about 0.3% to about 0.8% cinnamon, about 0.1% to about 0.5% nutmeg, about 0.1% to about 0.5% clove, and about 0.1% to about 0.5% cumin. The massaman curry paste contains no shellfish, such as shrimp.

The aqueous base may include water, rice milk, rice drink, coconut milk, coconut drink, or the like, or any combination thereof.

In accordance with one embodiment of the invention, the aqueous base is water.

In accordance with another embodiment of the invention, a method of preparing a massaman curry paste that is substantially free of major food allergens is disclosed. The curry paste is prepared by combining about 54% water by weight, about 20% pepper by weight, about 15% onion by weight, about 2% garlic by weight, about 2% galangal by weight, about 2% lemongrass by weight, about 0.6% kaffir lime peel by weight, about 0.6% coriander seeds by weight, about 0.6% cinnamon by weight, about 0.3% nutmeg by weight, about 0.3% clove by weight, and about 0.3% cumin by weight into a bowl and mixing the combination together.

### Example I

The massaman curry paste may be prepared as follows: Chop fresh garlic, lemongrass, onion and galangal and place into a blender. Add water (from about ½ cup to about 1 cup) and blend until liquefied or nearly liquefied. Pour the contents into a suitably sized bowl and add pepper, kaffir lime peel, coriander seeds, cinnamon, nutmeg, clove, cumin, and water. Stir until well mixed. The massaman paste is ready for use or may be frozen for later use.

In one preferred embodiment of the invention, a massaman paste was formulated having the following composition:

TABLE 1

| Ingredients | Weight Percent |
|---|---|
| Water | 53.5 |
| Pepper | 20.5 |
| Red Onion | 15.4 |
| Garlic | 2.5 |
| Galanga | 2.5 |
| Lemongrass | 2.5 |
| Kaffir lime peel | 0.64 |
| Coriander Seeds | 0.64 |
| Cinnamon | 0.64 |
| Nutmeg | 0.32 |
| Clove | 0.32 |
| Cumin | 0.32 |

In another preferred embodiment of the invention, a massaman paste was formulated having the following composition:

TABLE 2

| Ingredients | Weight Percent |
|---|---|
| Water | 43.5 |
| Pepper | 20.2 |
| Red Onion | 22.7 |
| Garlic | 3.8 |
| Galanga | 3.8 |
| Lemongrass | 3.8 |
| Kaffir lime peel | 0.53 |
| Coriander Seeds | 0.53 |
| Cinnamon | 0.53 |
| Nutmeg | 0.21 |
| Clove | 0.21 |
| Cumin | 0.21 |

The proportion of ingredients may be adjusted according the volume of massaman paste to be prepared. Additionally, it will be appreciated by those skilled in the art that dry or powdered garlic, galangal, lemongrass, and onion may also be used in appropriate proportions to achieve a similar flavor as that obtained by use of fresh ingredients.

### Example II

In accordance with another embodiment of the invention a culinary sauce is prepared for use in cuisine. The culinary sauce is substantially free of major food allergens. The culinary sauce may be prepared according to the following steps.

Place sunflower seeds on a baking sheet and bake for about 10 to about 20 minutes at 450° F. Good results have been obtained with a layer of seeds of about one inch in thickness. Chop or grind the seeds in a manner to retain a coarse texture.

In an appropriately sized container, add the sunflower seed pieces to the massaman curry paste along with water or rice milk. Add tamarind or other acidic solution. Mix in cane sugar, salt, and sunflower butter. If a smoother texture is desired, extra sunflower butter can be used as a substitute for the portion of sunflower seeds. After mixing, place ingredients in a saucepan and bring to a boil with frequent stirring. Remove the sauce from heat. The sauce is ready for use or may be bottled, refrigerated, or frozen for later use. To promote freshness of the sauce, particularly during refrigerated storage or at ambient temperatures, citric acid may be added to the mixture to bring the acidity to about pH 4.

In one preferred embodiment of the invention, a culinary sauce is formulated having the following composition:

TABLE 3

| Ingredients | Weight Percent |
|---|---|
| Water | 44 |
| Massaman curry paste | 14 |
| (formulation of Table 1) | |
| Sunflower butter | 14 |
| Tamarind | 11 |
| Cane sugar | 10 |
| Sunflower seeds | 7 |
| Salt | 0.4 |

In another preferred embodiment of the invention, a culinary sauce is formulated having the following composition:

TABLE 4

| Ingredients | Weight Percent |
|---|---|
| Water | 44 |
| Massaman curry paste | 14 |
| (formulation of Table 2) | |
| Sunflower butter | 11 |
| Tamarind | 13 |
| Cane sugar | 7 |
| Sunflower seeds | 11 |
| Salt | 0.4 |

In another preferred embodiment of the invention, a culinary sauce is formulated having the following composition:

TABLE 5

| Ingredients | Weight Percent |
|---|---|
| Water | 44 |
| Massaman curry paste | 14 |
| (formulation of Table 1) | |
| Sunflower butter | 21 |
| Tamarind | 11 |
| Cane sugar | 10 |
| Salt | 0.4 |

In another preferred embodiment of the invention, a culinary sauce is formulated having the following composition:

TABLE 6

| Ingredients | Weight Percent |
|---|---|
| Water | 44 |
| Massaman curry paste | 14 |
| (formulation of Table 2) | |
| Sunflower butter | 22 |
| Tamarind | 13 |
| Cane sugar | 7 |
| Salt | 0.4 |

In another preferred embodiment of the invention, a culinary sauce is formulated having the following composition:

TABLE 7

| Ingredients | Weight Percent |
|---|---|
| Water | 40 |
| Massaman curry paste | 13 |
| (formulation of Table 2) | |
| Sunflower butter | 10 |
| Tamarind | 20 |
| Cane sugar | 6 |
| Sunflower seeds | 10 |
| Salt | 0.4 |
| Citric acid (anhydrous) | 0.1 |

Citric acid may be added to lower the pH and promote the freshness of the sauce during storage. Preferably, the pH of the sauce during storage is about pH4. Other liquids may be used as a substitute for water, including but not limited to rice milk, rice drink, coconut milk, coconut drink, or the like.

While the invention has been illustrated and described in detail in the foregoing description, such an illustration and description is to be considered as exemplary and not restrictive in character, it being understood that only the illustrative embodiments have been described and that all changes and modifications that come within the spirit of the invention are desired to be protected. Those of ordinary skill in the art may readily devise their own implementations that incorporate one or more of the features described herein, and thus fall within the spirit and scope of the present invention.

We claim:

1. A food product comprising a curry paste wherein the curry paste consists essentially of:
an aqueous base, pepper, onion, garlic, galangal, lemongrass, kaffir lime peel, coriander seeds, cinnamon, nutmeg, clove, and cumin;
that is substantially free of shellfish products.

2. The food product of claim 1 wherein the curry paste consists essentially of:
about 45% to about 55% of an aqueous base by weight, about 15% to about 25% pepper by weight, about 10% to about 25% onion by weight, about 2% to about 5% garlic by weight, about 2% to about 5% galangal by weight, about 2% to about 5% lemongrass by weight, about 0.3% to about 0.8% kaffir lime peel by weight, about 0.3% to about 0.8% coriander seeds by weight, about 0.3% to about 0.8% cinnamon by weight, about 0.1% to about 0.5% nutmeg by weight, about 0.1% to about 0.5% clove by weight, and about 0.1% to about 0.5% cumin by weight.

3. A food product comprising a curry paste wherein the curry paste consists essentially of:
an aqueous base, pepper, onion, garlic, galangal, lemongrass, kaffir lime peel, coriander seeds, cinnamon, nutmeg, clove, and cumin;
that is substantially free of shrimp paste.

4. The food product of claim 1 wherein the aqueous base is water.

5. A food product comprising a sauce wherein the sauce consists essentially of an aqueous base, curry paste, sunflower butter, an acidic solution, sugar, sunflower seeds, and salt;
that is substantially free of major food allergens.

6. The food product of claim 6 further comprising citric acid.

7. The food product of claim 7 wherein the sauce consists essentially of about 40% to about 50% of an aqueous base by weight, about 10% to about 20% curry paste by weight, about 10% to about 20% sunflower butter by weight, about 5% to about 15% of an acidic solution by weight, about 5% to about 10% sugar by weight, about 5% to about 15% sunflower seeds by weight, about 0.1% to about 0.5% citric acid by weight, and about 0.1% to about 0.7% salt by weight.

8. The food product of claim 5 wherein the acidic solution includes at least one of the following:
tamarind extract, orange juice, grapefruit juice, lemon juice, tomato juice, and vinegar.

9. The food product of claim 8 wherein the acidic solution is tamarind extract.

10. The food product of claim 5 wherein the aqueous base includes at least one of the following:
water, rice milk, rice drink, coconut milk, and coconut drink

11. The food product of claim 10 wherein the aqueous base is water.

12. The food product of claim 6 wherein the acidity of the sauce is about pH 4.

13. A food product comprising a sauce wherein the sauce consists essentially of an aqueous base, curry paste, sunflower butter, an acidic solution, sugar, sunflower seeds, citric acid, and salt;
that is substantially free of peanut products, wheat products, and soy products.

14. A food product comprising a sauce wherein the sauce consists essentially of an aqueous base, curry paste, sunflower butter, an acidic solution, sugar, and salt;
that is substantially free of major food allergens.

15. The food product of claim 14 further comprising citric acid.

16. The food product of claim 15 wherein the sauce consists essentially of about 40% to about 50% of an aqueous base by weight, about 10% to about 20% curry paste by weight, about 15% to about 35% sunflower butter by weight, about 5% to about 15% of an acidic solution by weight, about 5% to about 10% sugar by weight, about 0.1% to about 0.5% citric acid by weight, and about 0.1% to about 0.7% salt by weight.

17. The food product of claim 14 wherein the acidic solution includes at least one of the following:
tamarind extract, orange juice, grapefruit juice, lemon juice, tomato juice, and vinegar.

18. The food product of claim 17 wherein the acidic solution is tamarind.

19. The food product of claim 14 wherein the aqueous base is water.

20. A method of preparing a culinary sauce comprising the steps of:
heating sunflower seeds until browned;
chopping the sunflower seeds;
adding the seeds to a mixture of a water, curry paste, sunflower butter, an acidic solution, sugar, citric acid, and salt; and
bringing the mixture to a boil.
